(19) United States
(12) Patent Application Publication
(10) Pub. No.: US 2006/0106910 A1
(43) Pub. Date: May 18, 2006

(54) Galois field polynomial multiplication

(75) Inventor: Wei An, Waltham, MA (US)

Correspondence Address: Randy J. Pritzker;Wolf, Greenfield & Sacks, P.C., 600 Atlantic Avenue, Boston, MA, 02210-2206, US

(73) Assignee: Analog Devices, Inc., Norwood, MA (US)

(21) Appl. No.: 10/990,314

(22) Filed: Nov. 16, 2004

(51) Int. Cl. G06F 7/52

(52) U.S. Cl. 708/607

(57) ABSTRACT

In one aspect, a multiplier for performing multiplication of a first operand and a second operand is provided. The multiplier comprises a matrix having a plurality of matrix elements arranged in a plurality of columns, a first plurality of storage elements to store at least a portion of the first operand, the first plurality of storage elements connected diagonally to the matrix, and a second plurality of storage elements to store at least a portion of the second operand, the second plurality of storage elements connected vertically to the matrix. In another aspect, a multiplier for computing at least a partial product of a first operand having a first length and a second operand having a second length is provided. The multiplier comprises a first register to store at least a portion of the first operand, a second register to store at least a portion of the second operand, and a logic matrix formed from a plurality of matrix elements that together perform a multiplication operation, the logic matrix connected to the first register and the second register such that each matrix element receives at least one bit from the first register and at least one bit from the second register, wherein a number of the plurality of matrix elements does not exceed a product of the first length and the second length.

### FIELD OF THE INVENTION

The present invention relates generally to multiplication operations and more particularly, to Galois field polynomial multiplication in a digital signal processor (DSP).

### BACKGROUND OF THE INVENTION

Polynomial multiplication may be an important component of many computations in a wide variety of applications. Galois field polynomial multiplication is often part of long code generation in wireless communication. For example, pseudo-noise (PN) sequences or codes are often computed from a generator or characteristic polynomial and employed as unique modern identifiers by wireless communication devices in a network such as code division multiple access (CDMA) communications systems. PN code generation may include one or more polynomial multiplication operations and may be time sensitive and require relatively fast computation.

Polynomial multiplication may be achieved by performing a number of successive shift and add operations, where the number of such operations is related to the length of the polynomial operands. For example, multiplication of a first polynomial of length n and a second polynomial of length m results in a product of length n+m−1. In general, each term in the output polynomial requires a shift and add operation (i.e., n+m−1 shift and add operations).

Implementing polynomial multiplication algorithmically often involves storing polynomial operands as a binary number or bit stream representing coefficients of the respective terms in the polynomial. Each of the n+m−1 operations may require checking for a non-zero coefficient in one of the polynomial operands (referred to as the indicator operand). Accordingly, each non-zero coefficient in the indicator operand requires essentially three operations (i.e., shift, check and add) and each zero coefficient requires essentially two operations (i.e., shift and check) as described in further detail below. Satisfactory performance in time critical applications may be jeopardized by the relatively large computation time for multiplication, particularly when the polynomials are arbitrarily long.

Some applications benefit from a priori knowledge of one of the operands. For example, the generator polynomial used by any of a variety of wireless communications standards (e.g., CDMA2000, Universal Mobile Telecommunications System (UMTS), wideband CDMA (WCDMA), etc.) may be known. Under these circumstances, a look-up table (LUT) storing all or a subset of the possible products of a known polynomial with an unknown polynomial may be formed to obviate term-by-term shift and add operations. However, as the length of the unknown polynomial operand increases, the size of the LUT necessary to store all the possible product combinations tends to become unwieldy. More importantly, this method is only viable for the set of applications where one of the polynomial operands is known.

### SUMMARY OF THE INVENTION

One embodiment according to the present invention includes a multiplier for performing multiplication of a first operand and a second operand, the multiplier comprising a matrix having a plurality of matrix elements arranged in a plurality of columns, a first plurality of storage elements to store at least a portion of the first operand, the first plurality of storage elements connected diagonally to the matrix, and a second plurality of storage elements to store at least a portion of the second operand, the second plurality of storage elements connected vertically to the matrix.

Another embodiment according to the present invention includes a multiplier for performing multiplication of a first operand and a second operand, the multiplier comprising a plurality of matrix elements logically arranged in a plurality of computation elements, each computation element connected serially to compute an output bit of a product of the first operand and the second operand, a first plurality of storage elements to store at least a portion of the first operand, the first plurality of storage elements connected to the plurality of matrix elements such that each of the plurality of first storage elements provides a value stored therein to no more than one matrix element at any rank in any one of the plurality of computation elements except within the computation element to which the storage element provides an initial bit, and a second plurality of storage elements to store the second operand, the second plurality of storage elements connected to the plurality of matrix elements such that each of the plurality of second storage elements provides a value stored therein only to matrix elements of a same rank.

Another embodiment according to the present invention includes a multiplier for computing at least a partial product of a first operand having a first length and a second operand having a second length, the multiplier comprising a first register to store at least a portion of the first operand, a second register to store at least a portion of the second operand, and a logic matrix formed from a plurality of matrix elements that together perform a multiplication operation, the logic matrix connected to the first register and the second register such that each matrix element receives at least one bit from the first register and at least one bit from the second register, wherein a number of the plurality of matrix elements does not exceed a product of the first length and the second length.

Another embodiment according to the present invention includes a multiplier for performing multiplication of a first operand and a second operand, the multiplier comprising a first register to store at least a portion of the first operand, and a plurality of matrix elements arranged in groups, each group connected to compute a respective output bit of a product between the first and second operand, wherein a first matrix element in each group is connected to receive a respective initial bit of the first register, each group having a number of matrix elements less than or equal to a bit position of the first register storing the respective initial bit.

### BRIEF DESCRIPTION OF THE DRAWINGS

FIGS. 1A and 1B illustrate a characteristic polynomial and an associated polynomial representation as a binary number, respectively;

FIG. 2A illustrates a first polynomial and a representation of the first polynomial and a second polynomial and a representation of the second polynomial;

FIG. 2B illustrates a multiplication between the first polynomial and the second polynomial shown in FIG. 2A;

FIG. 3 illustrates a conventional multiplication circuit;

FIG. 4 illustrates a schematic view of the multiplication circuit of FIG. 3;

FIG. 5 illustrates a multiplier in accordance with one embodiment of the present invention;

FIG. 6 illustrates a schematic representation of the multiplier of FIG. 5;

FIG. 7 illustrates one initialization of the multiplier of FIG. 6, in accordance with one embodiment of the present invention;

FIG. 8 illustrates another initialization of the multiplier of FIG. 6, in accordance with one embodiment of the present invention;

FIG. 9 illustrates another initialization of the multiplier of FIG. 6, in accordance with one embodiment of the present invention;

FIG. 10 illustrates an arrangement of a multiplier in accordance with one embodiment of the present invention;

FIG. 11 illustrates another arrangement of a multiplier in accordance with one embodiment of the present invention;

FIG. 12 illustrates a fixed maximum length multiplier in accordance with one embodiment of the present invention;

FIG. 13 illustrates an arrangement of the multiplier of FIG. 12, in accordance with one embodiment of the present invention;

FIG. 14 illustrates a conventional masked linear feedback shift register (LFSR);

FIG. 15 illustrates a sequence generator having a multiplier in accordance with one embodiment of the invention; and

FIG. 16 illustrates another sequence generator having a multiplier in accordance with embodiment of the invention.

### DETAILED DESCRIPTION

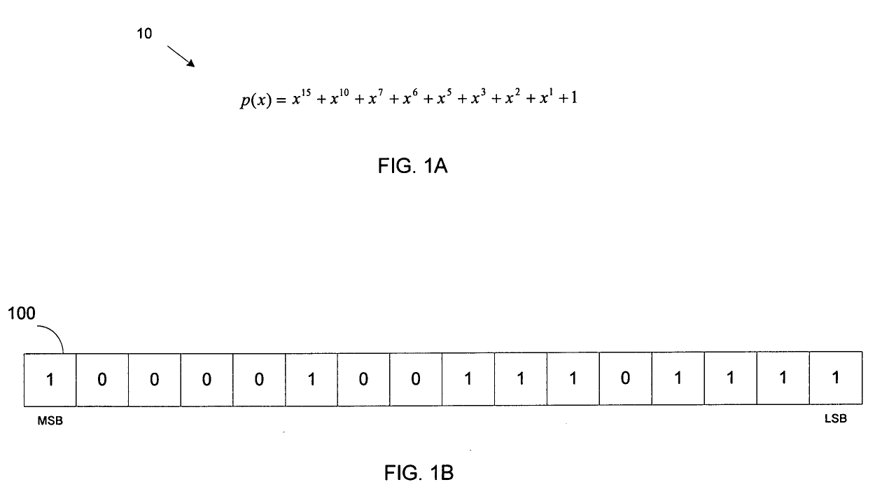

Processor based computations involving polynomials often involve storing the coefficients of each term of the polynomial. For example, FIG. 1 A illustrates a polynomial 10. FIG. 1B illustrates a register 100 storing coefficient values for polynomial 10. The LSB bit, for example, may store the coefficient value of the x⁰ term, and the MSB may store the coefficient value for the highest exponent term of the polynomial (e.g., the coefficient value of the x¹⁵ term). Accordingly, the position of the coefficient value in the register implicitly provides the order of the associated term. It should be appreciated that once stored, the representation of the polynomial is simply a binary number. Accordingly, the aspects of the invention are not limited to multiplication of operands that represent a polynomial as any number, data, code or other information may be used as an operand in a multiplication operation.

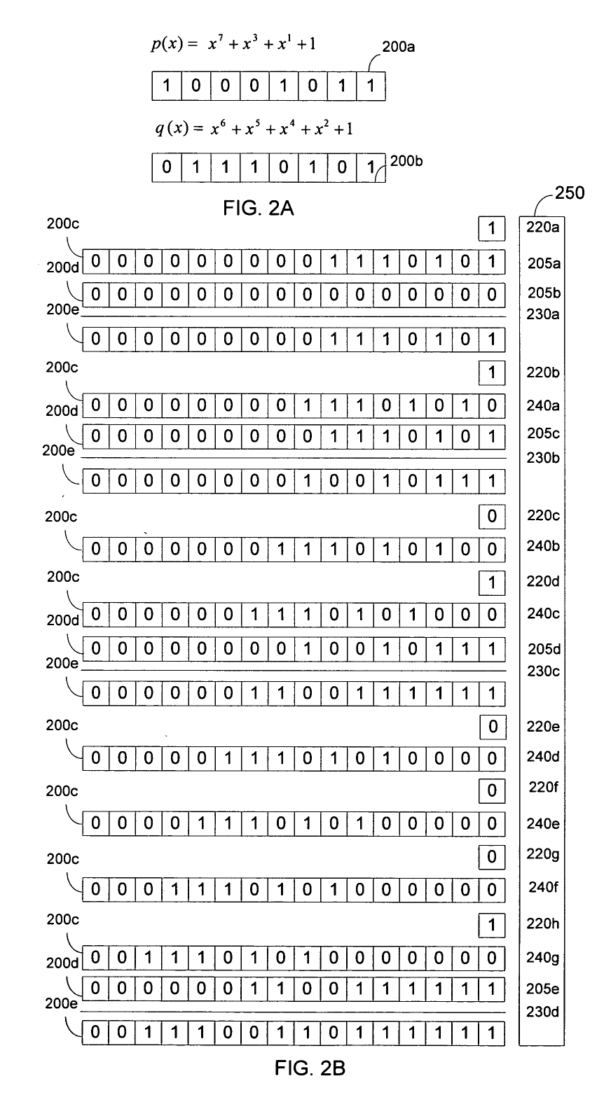

There are numerous methods of performing a multiplication. FIGS. 2A and 2B illustrate a conventional polynomial multiplication in Galois field mathematics using “shift and add” operations. In Galois field, addition is performed as a logical exclusive-OR (XOR) operation of its operands. FIG. 2A illustrates a first polynomial p(x) and a second polynomial q(x), which have associated polynomial representations (e.g., as coefficients of the various terms in the polynomials) stored in register 200a and 200b, respectively. The term “polynomial representation” refers generally to any collection of data arranged to store information about a polynomial. In general, all the information of a polynomial may be extracted either explicitly or implicitly from its polynomial representation.

In Galois field arithmetic (e.g., GF(2)), the product p(x)*q(x) may be computed by iteratively performing XOR operations on the polynomial representation of q(x) (i.e., the operator) as indicated by the bits in the polynomial representation inp(x) (i.e., the indicator), or vice versa. The choice of which operand is the operator and which is the indicator is not significant and may depend on the application. For example, the polynomial of higher order may be chosen as the indicator or in applications where a known generator polynomial is used, the generator polynomial may be used as the operator.

Algorithm 250 shown in FIG. 2B may be performed on a processor, such as a digital signal processor (DSP). In FIG. 2B, the registers storing the operands, various intermediary results, and ultimately the product are 16 bit registers. In step 205a, the operator (e.g., the representation of q(x)) may be loaded into a register 200c and padded with zeroes to account for any difference between the length of register 200c and the order of polynomial q(x). An initial state is loaded into register 200d at step 205b. Typically, the initial state is simply zeroes; however, the initial state can be any desired value.

At step 220a of algorithm 250, the value of the least significant bit (LSB) of the indicator (e.g., the representation of p(x)) is determined, i.e., the “check” step discussed above.

A value of 1 indicates that the operator should be XOR'ed with the value currently stored in register 200d and a value of zero indicates that no XOR operation should be performed. Since the value of the LSB of the indicator is one, the initial state is XOR'ed with the operator at step 230a to produce the next state or accumulated value in register 200e. The next most significant bit of the indicator is checked at step 220b and the operator is shifted one bit position to the left so that it corresponds with the order or bit position of the corresponding indicator bit. That is, the operator is shifted once each time a new bit of the indicator is checked. Since the value of the indicator bit of the first order term (i.e., the next bit from the LSB) is also one, the shifted operator is XOR'ed with the accumulated value at step 230b to provide a new accumulated value in register 200e.

As shown by check step 220c, the next most significant bit of the indicator is a zero. Accordingly, no XOR operation is performed. However, the operator is still shifted one bit position to the left (as shown by shift step 240b) such that the number of operator shifts matches the order of the term of the corresponding indicator bit. This process is repeated until the final bit of the indicator has been checked at check step 220h. Register 200e stores the product p(x) *q(x) after the final XOR operation in XOR step 230d. It should be appreciated that the above operation may include various other register manipulations not shown (e.g., loading register 200d with the result of XOR operations 230, etc.) which adds further expense to the computation.

The operation described above may be implemented on a processor, for example, a DSP by appropriately shifting the bits at the register level and performing the corresponding XOR operations. However, as the length of the operands grows, the number of operations required to compute a product may jeopardize time sensitive computations. Accordingly, multiplication may not be feasible using conventional methods when operands become large. For example, a software implementation of algorithm 250 may not be suitable for some real time applications, such as CDMA wireless communications.

As discussed above, in some applications, one of the operands may be known a priori, and a look-up table may be used to speed up the multiplication operation. For example, in a particular application, p(x) may always be the same such as when p(x) is a generator polynomial in a CDMA communications network. The maximum order that q(x) will achieve may also be known. The productp(x)*q(x) may then be precomputed for every possible q(x) and stored in a memory in the form of a look-up table. Accordingly, for a q(x) having an order less than or equal to n, a look-up table having 2ⁿ precomputed entries could exhaustively determine any productp(x)*q(x). Each entry will have a length n+m−1, where m is the order of the generator polynomial (e.g., p(x)), to produce a table of size 2ⁿ (n+m+1) bits. The polynomial representation of q(x) (e.g., a coefficient representation) may be used to index the look-up table to obtain the associated product p(x)*q(x).

As the maximum permitted order of q(x) increases, so does the size of the dedicated storage necessary to store the corresponding look-up table. Moreover, the look-up table approach does not provide a generalized solution to the problem of multiplication. In particular, one of the product operands must be known. To avoid much of the computational expense of performing shift-and-add algorithms (i.e., software implementations) and to obviate the need for large memories to store LUTs, multiplication operations may be performed in hardware. However, conventional hardware implementations often require extensive logic and chip area and may consume relatively large amounts of power.

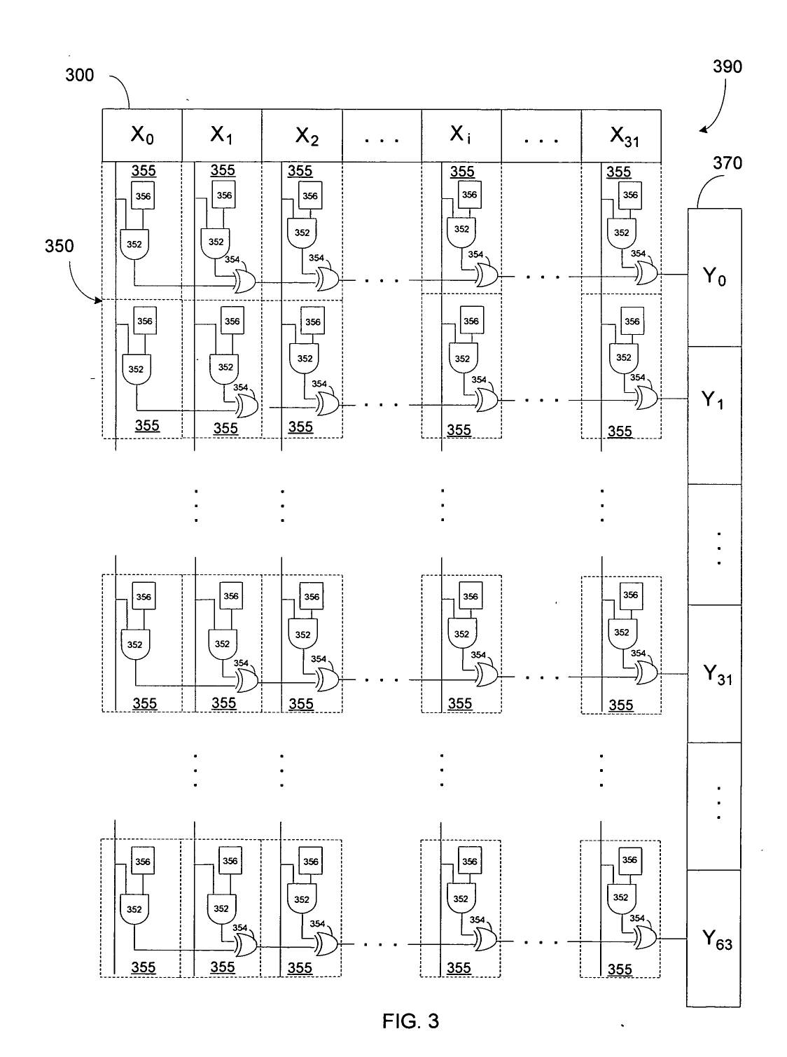

FIG. 3 illustrates a conventional hardware solution to multiplication. When a multiplication operation is desired, the multiplication operands may be used to properly initialize the hardware. Multiplier 390 includes matrix 350, input register 300 and output register 370. The size of matrix 350 is related to the size of input register 300. Increasing the register length increases the size of the matrix. Input register 300 stores one of the operands of a multiplication operation.

Matrix 350 includes a regular grid of matrix elements 355. Each matrix element may include an AND gate 352 and an XOR gate 354 connected to a respective internal flip-flop 356 columned with respective bits of input register 300. Each row of matrix elements is serially connected, the highest ranked matrix element in the row providing the XOR of each of bits X₀-X₃₁ to compute a single bit stored in output register 370. The term “rank” refers to a position of a matrix element in a plurality of the serially connected matrix elements. Accordingly, the first column may not include XOR gate 354. Internal flip-flops 356 store values associated with the other operand not stored in input register 300 (e.g., the indicator operand).

The effect of any matrix element 355 can be effectively turned on or off by initializing the corresponding flip-flop to a high or low level, respectively, and the operation performed by the matrix depends on the initialization of the flip-flops. Performing a multiplication operation requires a particular initialization. The operator may be loaded into the input register 300. Therefore, the initialization of the flip-flops will be guided by the indicator. As discussed above, in connection with FIG. 2B, one method of multiplying two numbers is to successively XOR together shifted versions of the operator with itself, where each XOR is determined by non-zero bits in the indicator. Therefore, zero bits in the indicator effectively represent no-ops, except for the corresponding shift. However, the shifting of the operator stored in input register 300 is performed by the configuration of connections in the matrix, rather than shifting the operator at the register level.

The least significant bit of the operator (e.g., the leftmost bit of register 300) is the only relevant bit in determining the least significant bit of the product. This can be seen by examining algorithm 250 in FIG. 2B where the LSB in 200c at step 205a is XOR'd with successive zeroes that are shifted into the register to produce the LSB of the product stored in register 200e after step 230d. For example, if the LSB of the indicator is zero, the LSB of the product is zero. If the LSB of the indicator is one, the LSB of the product is equal to the LSB of the operator. Accordingly, flip-flop 356 in the first row and column is initialized with the value of the LSB of the indicator. Since the LSB of the operator (e.g., bit X₀) is the only bit to have an effect on the LSB of the product (e.g., bit Y₀), all other flip-flops 356 in the first row are set to zero. In addition, flip-flops 356 along a diagonal (shown as shaded matrix elements) are set to the LSB of the indicator to generate the appropriate XOR. For example, the diagonal beginning at the matrix element in the first row and first column includes each bit of the operator stored in register 300. Setting the flip-flops 356 of this diagonal to the LSB of the indicator bit achieves the load operation in step 205a in FIG. 2. Stated differently, since a non-zero indicator bit indicates that an XOR operation of an entire shifted version of the operator should be performed, flip-flops on the diagonal from a flip-flop corresponding to the current non-zero indicator bit are set to one. Similarly, the diagonal corresponding to a zero indicator bit are all set to zero.

The second output LSB (i.e., bit Y₁) is only affected by the values of X₀ and X₁. Therefore, all subsequent flip-flops in the second row subsequent to matrix elements in columns associated with bits X₀ and X₁ are set to zero. The flip-flop in the first matrix element in the second row is set to equal the second LSB of the indicator as well as all flip-flops along the corresponding diagonal. This process is repeated for each bit in the indicator. The initialized matrix performs a multiplication between the operator stored in input register 300 and the indicator used to initialize the flip-flops in matrix 350.

Matrix 350 is relatively expensive from a hardware standpoint. This is due in part to the general nature of matrix 350, and in particular, that matrix 350 presents a generic XOR matrix designed to perform various operations including multiplication, depending on how the grid of internal flip-flops are initialized. The cost of generality is that individual operations such as multiplication may not require all of the available circuitry.

For example, providing a conventional matrix 350 that can perform multiplication on operands of length N and M, respectively, may require N(N+M−1) matrix elements. Each matrix element (excepting an LSB column) may include a flip-flip, an AND gate, an XOR gate and the necessary interconnections. However, many of the matrix elements are not used during multiplication. In particular, many of the matrix elements must be specifically initialized to zero to remove them from the operation. This is not only a waste of hardware, but requires additional computation time, complexity and power to initialize logic that functionally has no purpose in a multiplication operation.

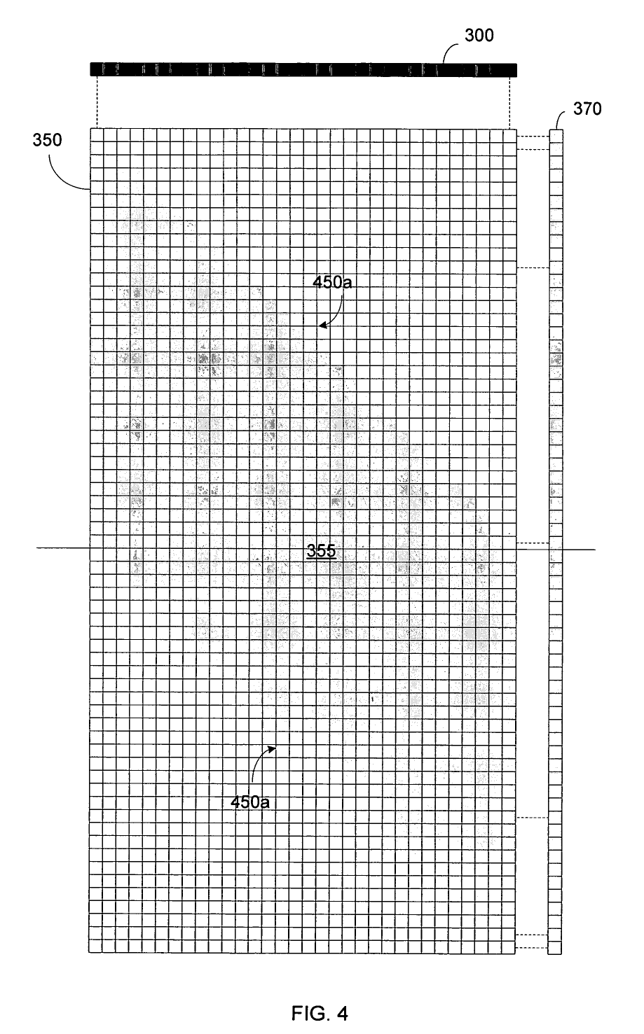

The superfluous circuitry of matrix 350 can be better appreciated by considering FIG. 4. FIG. 4 illustrates schematically the general structure of the matrix 350. Each square 355 denotes a matrix element. To better illustrate the higher level structure and organization of the multiplier, the logic in each matrix element is not illustrated. However, it should be appreciated that each matrix element include the logic shown in FIG. 3 and is connected in the same manner.

As discussed above, only a portion of the matrix elements are used in a multiplication, the remainder is initialized to zero to remove them from the computation. Shading is used to indicate which elements are involved in performing a multiplication, i.e., to illustrate the active matrix elements. The un-shaded matrix elements are initialized to zero to remove them from the computation, regardless of the value of the operands. Accordingly, essentially half of the matrix is unused in the multiplication operation. Not only does the unused circuitry consume space and power, it requires the additional computation time necessary to initialize the matrix correctly to effectively remove the inactive elements from the multiplication operation.

Applicant has developed various multipliers having reduced hardware requirements to perform multiplication operations that may save space, cost and power in the resulting device. For example, a DSP may be designed having a hardware multiplier having substantially half of the hardware required for the matrix illustrated in FIGS. 3 and 4.

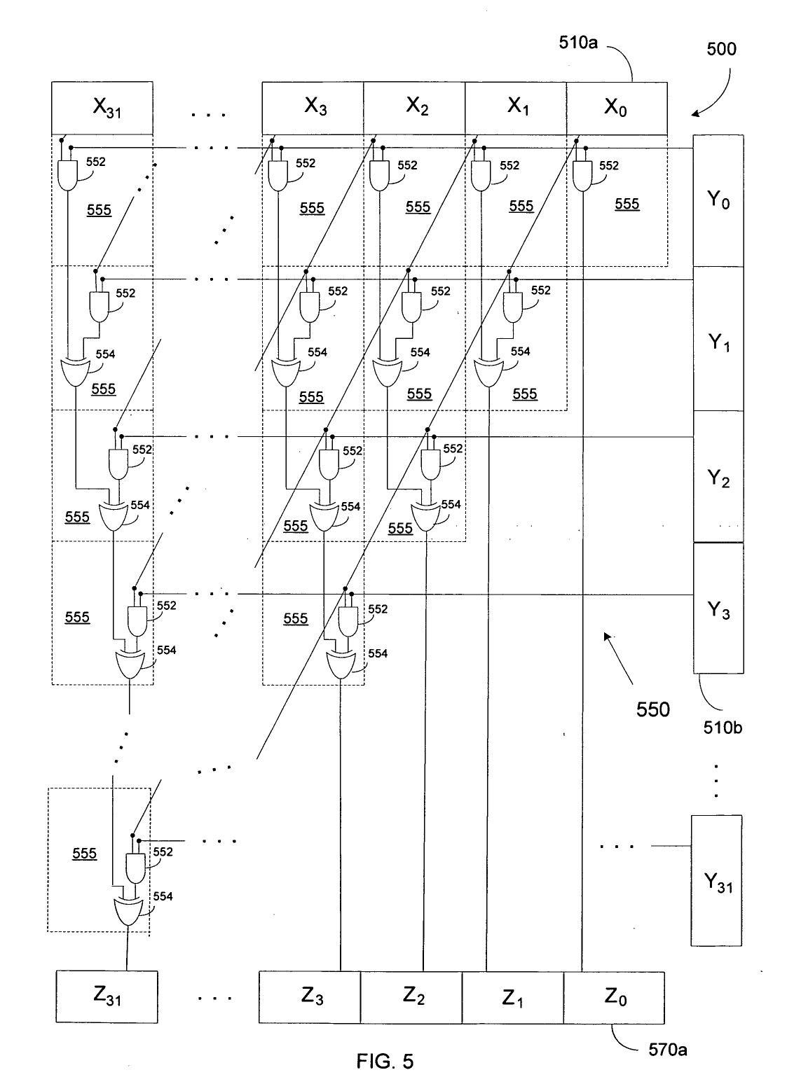

FIG. 5 illustrates one embodiment of a multiplier according to the present invention. Multiplier 500 includes an input register 510a and an input register 510b to store operands of a multiplication. The input registers 510a and 510b are connected to a matrix 550 having a plurality of matrix elements 555. It should be appreciated that matrix elements 555 do not include internal flip-flops. The function of the internal flip-flops may be replaced by input register 510b and the associated connections as described below.

Each matrix element 555 receives as input to an AND gate 552 a corresponding bit from each of input registers 510a and 510b. In particular, the upper rightmost matrix element forms the AND of bit X₀ and Y₀, the next matrix element over in the same row forms the AND of bit X₁ and Y₁, etc. Each matrix element (except the first row) also includes an XOR gate 554 that performs an XOR between the AND of the immediate matrix element and the XOR result of the previous element in the same column. Input register 510a is diagonally connected across columns of the matrix. A diagonal connection is a connection from an input register to a matrix, wherein each connection from a bit in a register is made to a matrix element in a different row and column. The diagonal connections of input register 500a synthesize a shift operation.

Each matrix element in the first row takes an initial bit from one of the bit positions of input register 500a. The term “initial bit” refers to a bit of an input register (e.g., a flip-flop from a collection of storage elements) that is connected directly to a first matrix element in a column. Accordingly, each column can be viewed as corresponding to the bit position of the input register from which it receives its initial bit. Accordingly, each column in matrix 550 may include a number of matrix elements equal to a bit position of input register 510a from which it receives its initial bit (i.e., the first column from the right receives an initial bit from the first bit position X₀ and therefore has only a single matrix element. The second column from the right receives an initial bit from the second bit position X₁ and therefore has two matrix elements, etc.).

Input register 510b is vertically connected to the matrix. A vertical connection is a connection from an input register to a matrix, wherein each connection from a bit of the register is connected to a matrix element in a same row. In the embodiment in FIG. 5, each matrix element forms a logical AND of a bit from input register 510a and 510b that determines whether the matrix element will contribute to the XOR operation in the associated column. Each column computes a single output bit and stores the output in a respective bit of register 570a.

The diagonal connection of matrix 550 facilitates reducing the number of matrix elements in the multiplier. In addition, the internal flip-flops (which provided redundant information) have been replaced by a single register 500b appropriately connected to the matrix. Matrix 550, therefore, takes on a characteristic triangular shape, where each successive column includes an additional matrix element to form a computation element. The term “computation element” refers generally to a collection of matrix elements that together compute a single bit of the product of a multiplication.

It should be appreciated that matrix 550 performs a multiplication operation of operands stored in input registers 510a and 510b. However, it should be appreciated that matrix 550 computes only a partial product. As shown in FIG. 4, the active elements of multiplier 400 form a parallelogram. The parallelogram may be viewed as comprising two triangular regions 450a (shown in darker shading) and 450b (shown in lighter shading). Matrix 550 performs the partial multiplication of region 450a. Accordingly, to perform a full multiplication a second similar matrix may be provided to perform the partial multiplication computed by region 450b.

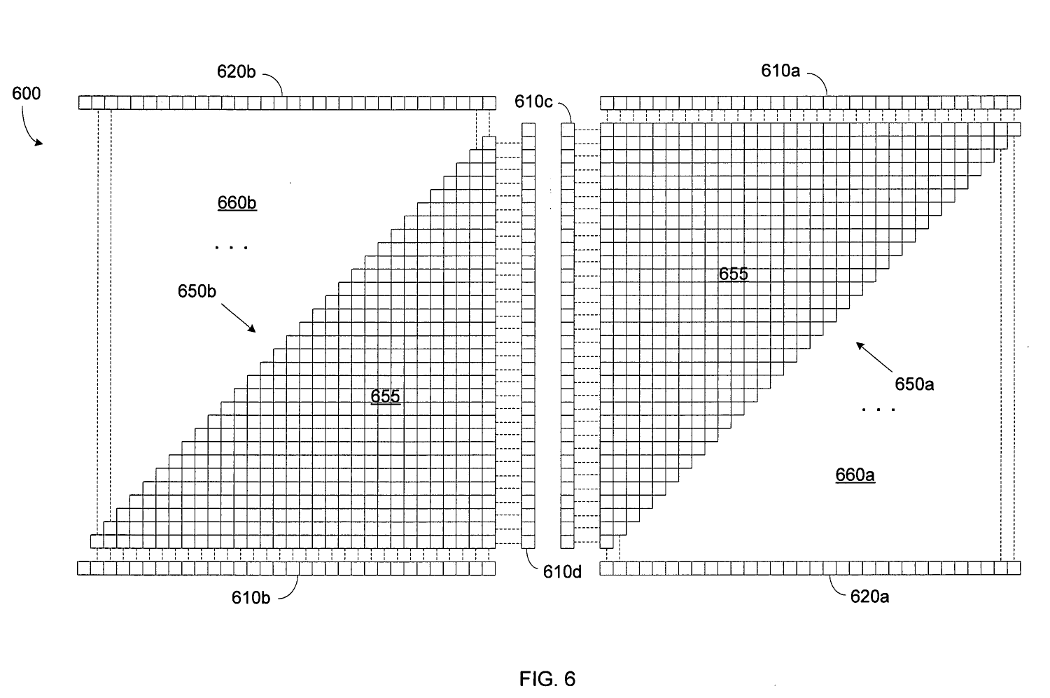

To better illustrate various aspects of the present invention, a multiplier substantially connected as illustrated in FIG. 5 is shown schematically in FIG. 6. Each square 655 represents a matrix element that together with other matrix elements in the same column forms a computation element that generates one bit of the resulting product stored in registers 620a and 620b. As shown, multiplier 600 includes two essentially identical matrices 650a and 650b such that full multiplication may be computed.

Matrices 650a and 650b (collectively matrix 650) are comprised of matrix elements 655 arranged to perform multiplication operations. While the logic of each element is not shown, it should be appreciated that matrix elements may include the generally repeatable pattern of logic in a multiplication (e.g., a combination of an AND gate and an XOR gate). Multiplier 600 also includes various registers to store the multiplication operands. For example, circuit 600 may include input registers 610a and 610b to store information related to the operator and input registers 610c and 610d to store information related to the indicator. Output registers 620a and 620b store the product computed by multiplier 600.

Matrix 650a may be connected to input registers 610a and 610c and output register 620a in substantially the same way illustrated in the embodiment illustrated in FIG. 5 (Input register 610c is illustrated at the opposite side of the array). Similarly, matrix 650b may be connected to input registers 610b and 610d to store at least portions of operands of a desired multiplication. Once the multiplier has been initialized by appropriately loading the registers, the connections in matrix 600 perform a multiplication operation between the two operands stored in input registers 610 and store the product in output registers 620.

The initialization of the registers (i.e., how the various input registers are loaded with the operands) will depend on the characteristics of the operands. In particular, the lengths of the two operands may guide how the input registers are to be initialized. As discussed above, it may be desirable to perform multiplication of operands of unknown value and of variable length. Multiplier 600 is capable of performing generally efficient multiplication on operands of unknown value and/or of variable length by appropriately initializing the input registers.

It should be appreciated that the size of the operands of a multiplication may be limited by the size of the registers. For example, multiplier 600 supports a product having 64-bits. This limitation may affect the size of the operands that may be operated on. In some cases, the registers provided in a multiplier will have a length conducive to the operation of the processor. For example, processors often operate on registers of length 2^{k}, where k is the integers 1, 2, 3 . . . N.

For example, assume that the output registers of a multiplier (e.g., output registers 620a and 620b) combine to a length that matches the data bus of an associated DSP. That is, the width of the output registers matches the output bandwidth of the DSP. For an L-bit output bandwidth (and therefore a resulting product of L-bits) the sum of the length of the two operands may be limited to L+1 to satisfy the constraint that the length of a product is the sum of the lengths of the operands minus one.

Applicant has appreciated that variable length multiplication may be achieved on fixed length registers (at a fixed output bandwidth) by appropriately initializing the input registers. In variable length multiplication, the maximum length of one operand may depend on the length of the other. As the length of the shorter operand gets smaller, the length of the longer operand is permitted to increase and still not exceed the output bandwidth of the processor.

For example, assume an output bandwidth of 64 bits. At one extreme, one of the operands is a single bit, and the other operand is allowed to be 64 bits in length. As the operand having the shorter length includes additional bits, the maximum length of the other operand decreases by the same amount to preserve the output bandwidth. As the operands converge to the same length, the maximum length of one operand is 33 bits and the other operand is 32 bits. To properly initialize the input registers, a length of at least one of the operators may need to be specified.

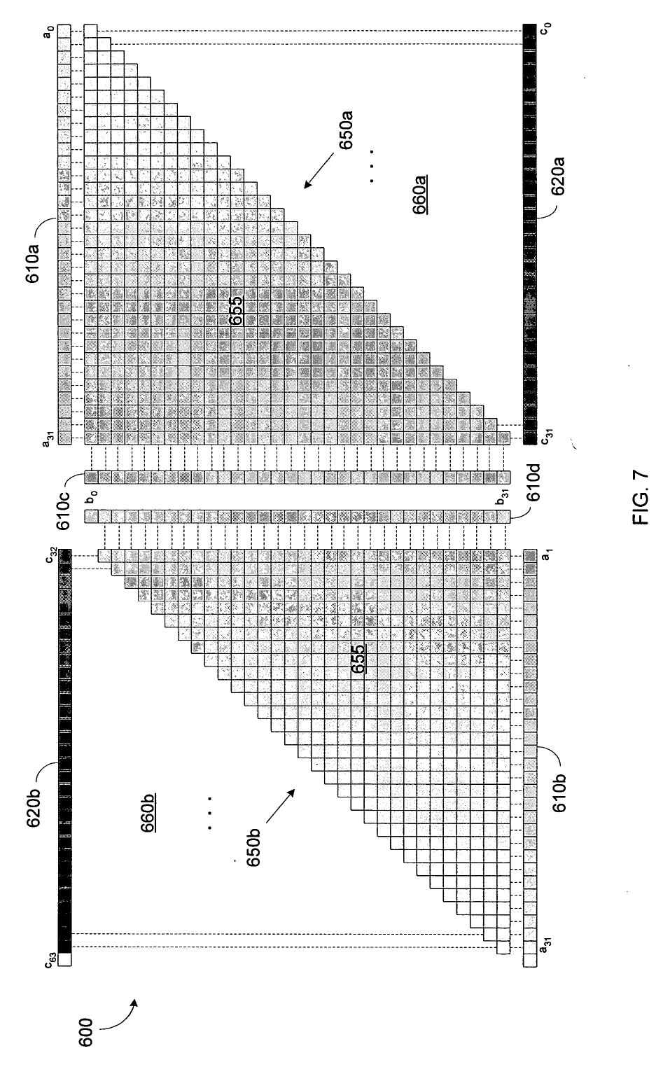

FIGS. 7-10 illustrate exemplary register initializations for a variety of operand length configurations that may arise during variable length multiplication. FIG. 7 illustrates an initialization of multiplier 600 when the operands are at a maximum configuration. The term “maximum configuration” refers to a configuration wherein the shorter operand is the same length as the register that stores the operand. Multiplier 600 has a maximum configuration when both operands are 32 bits long. While one of the operands could be increased in length by one, it may be more convenient from an implementation standpoint to use registers having 2^{k} length. One of the operands may be loaded into input register 610a from the LSB at a₀ to the MSB at a₃₁. Similarly, the other operand may be loaded into input register 610c from the LSB at b₀ to the MSB at b₃₁. Shading is again used to indicate active matrix elements or bit positions in a register storing operand information. As indicated by the shading, each bit of input registers 610a and 610c stores a respective bit of the operands. As a result, each matrix element 655 of matrix 650a is active in the multiplication to provide the partial product stored in output register 620a.

It should be appreciated that matrix 650a computes only the lower 32 bits of the product. To compute the higher order bits of the product, matrix 650b may initialized in a similar manner. In particular, bits of the operand loaded into input register 610a may be loaded into input register 610b from LSB a₁ to MSB a₃₁, respectively, and the other operand may be loaded into input register 610d from LSB b₀ to MSB b₃₁ such that matrix 750b computes the higher order bits of the product. Accordingly, output registers 720a and 720b store the full product a*b. Computation of the higher order bits need not include bit a₀ or b₀ because matrices 650a and 650b may not be perfectly symmetric. That is, all computations involving bit a₀ are performed by matrix 650a and all contributions of the bits indicated by b₀ are accounted for by the first row of matrix 650a.

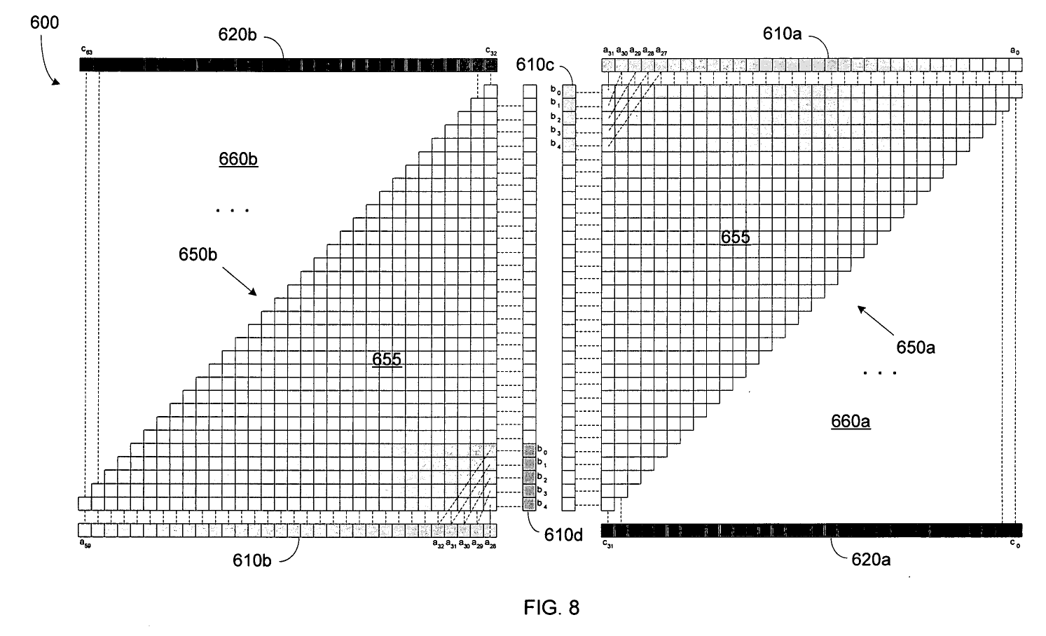

FIG. 8 illustrates an exemplary initialization of multiplier 600 when one of the operands exceeds the maximum length supported by the length of the input register 610a (e.g., exceed 32-bits). It should be appreciated that if one operand exceeds this register length, the other operand must be less than the register length to ensure that the output bandwidth is not exceeded. Multiplier 600 in FIG. 8 is initialized to perform a multiplication between a first operand of length 5 and a second operand of length 60. The first operand may be loaded into input registers 610c and 610d from b₀ to b₄ as shown.

To initialize the input registers 610a and 610b, the first 32 bits of the second operand may be stored in input register 610a from LSB a₀ to bit a₃₂. As illustrated, the highest order bit of the product computed by matrix 650a (e.g., output bit c₃₁ of output register 620a) is the XOR of bits a₂₇, a₂₈, a₂₉, a₃₀ and a₃₁. Accordingly, the next bit of the product (e.g., output bit c₃₂ of output register 620b) should be the XOR of bits a₂₈, a₂g, a₃₀, a₃₁ and a₃₂. To achieve this, a number of the bits stored in input register 610a must be repeated in input register 610b (i.e., bits a₂₈-a₃₁), for the same reason a₁-a₃₁ were repeated in the initialization of multiplier 600 in FIG. 7.

It should be appreciated that the number of bits repeated in input register 610b is a function of the length of the first (i.e., the shorter) operand. In particular, the number of repeated bits equals the length of the shorter operand minus one. The number of repeated bits increases with the length of the shorter operand to the boundary case illustrated in the initialization of FIG. 7 wherein all but a single bit (a₀) was repeated. As illustrated by shading, only a portion of the matrix elements are active in the multiplication in FIG. 7, the inactive matrix elements do not contribute to the computation. Once initialized as described above, output registers 620a and 620b store the full product a*b.

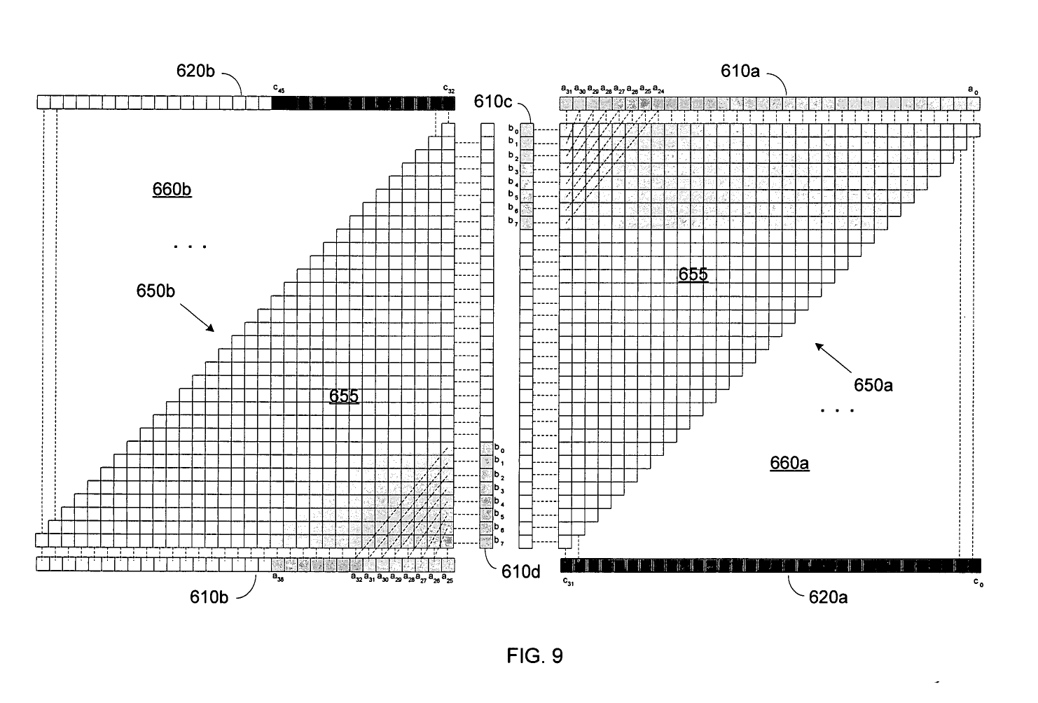

FIG. 9 illustrates an initialization that performs a multiplication wherein the sum of the lengths of the two operands is less that the output bandwidth by more than a single bit. For example, multiplier 600 is initialized to perform a multiplication between a first operand of length 8 and a second operand of length 39. As with the multiplication illustrated in FIG. 8, the bits of the shorter operand are loaded into input registers 610c and 610d from b₀-b₇ as shown, and the first 32 bits of the longer operand are loaded into register 610a. Since the shorter operand has a length of eight, the seven most significant bits (i.e., a₂₅-a₃₁) in input register 610a are repeated in register 610b and the remainder of the higher order bits (i.e., a₃₂-a₃₈) are loaded into register 610b. The bit positions of input register 610b not storing bits of the operand may be padded with zeroes to remove their effect from the computation.

Any multiplication of operands having a product less than or equal to the output bandwidth may be computed by initializing the multiplier appropriately. Applicant has appreciated that knowledge of the length of the shorter operand is sufficient to properly initialize the matrix. For example, each of the initializations described above (and any initialization wherein the output bandwidth is respected) shares a similar initialization. First, the shorter operand is stored in input registers 610c and 610d. Next, as much of the longer length operand is stored in input register 610a and a number of bits of the longer operand are repeated in input register 610b according to the length of the shorter operand. As such, the length of the shorter operand is a variable of interest in initialization.

Applicant has recognized that an instruction that specifies the length of the shorter operand (and the value of each operand) may be sufficient to initialize and perform variable length multiplication of unknown operands. Many DSPs are designed to operate on data of a specified word length. Various DSPs, for example, may operate on 32-bit, 64-bit, 128-bit data, etc. A DSP may operate more efficiently when the corresponding word lengths of the DSP are observed; for example, register lengths that are equal to or factors of this word length. Accordingly, a multiplier may operate efficiently when the output bandwidth is related to this word length. Computing a product of a length greater than a word length preferred by the architecture of the DSP, may result in substantial slowdown in operation.

In one embodiment according to the present invention, a multiplication instruction may be defined as,
Rsd=PMUL Rmd BY Rnd (1)

Where Rsd, Rmd and Rnd are registers and PMUL is the multiplication operation code (opcode). The length of Rsd, in general, defines the output bandwidth and may be of any length. Typically, the length of Rsd will depend at least in part on the architecture of the processor. Consider a DSP having a 64-bit output bandwidth. To satisfy this constraint, the total length of the two operands should be equal to or less than 64 bits. Rsd may be, for example, double 32-bit registers, a single 64-bit register, quad 16-bit registers, etc. PMUL is the opcode indicating that a value stored in Rmd is to be multiplied by a value stored in Rnd. Rmd and Rnd may each be 64-bit registers. Rnd may comprise a 32-bit high register Rnh and a 32-bit low register Rnl. The high and low registers may include different information. For example, the low register Rnl may include the operand having the shorter length. The high register Rnh may include the valid length of the operand stored in Rnl (e.g., the most significant bit position having a non-zero value). Register Rmd may contain the operand of the longer length.

The arrangement described above permits multiplication with variable length operands as long as the product does not exceed the output bandwidth (e.g., 64 bits). As discussed above, at one extreme, the longer operand has a 64-bit representation and is stored in register Rmd. Accordingly, the shorter operand having a single bit representation is stored in Rnl and the length of the shorter operand is stored in Rnh (e.g., a length of one). Rnh may store the length of the operand in Rnl by indicating the highest non-zero bit position, or any other method that indicates of the length of the operand.

At the other extreme, both operands are 32-bits long. Under these circumstances, it is not significant which of the two operands is stored in Rmd. The other polynomial representation is stored in Rnl and Rnh is set to indicate that the operand stored in Rnl has a length of 32. It should be appreciated that this arrangement can accommodate polynomial operands of any length in between these two extremes.

The general form illustrated in (1) can be used, for example, in a DSP architecture having any output bandwidth and is not limited to the bandwidths or register sizes specifically mentioned herein. In general, the instruction shown in (1) provides a format to specify a variable length multiplication that can be applied to various embodiments of multipliers according to the present invention. For example, the value stored in Rnl may be loaded into input registers 610c and 610d of multiplier 600. The lower order bits (e.g., the first 32 LSB bits of Rmd) may be loaded into input register 610a. The number stored in Rnh (i.e., the length of the shorter operand) may be used to index back into the lower order bits of Rmd. The bits from the position of the index into the lower order bits to the MSB of Rmd may be loaded into input register 610b. Thus initialized, multiplier 600 performs a multiplication between the operands indicated in the instruction.

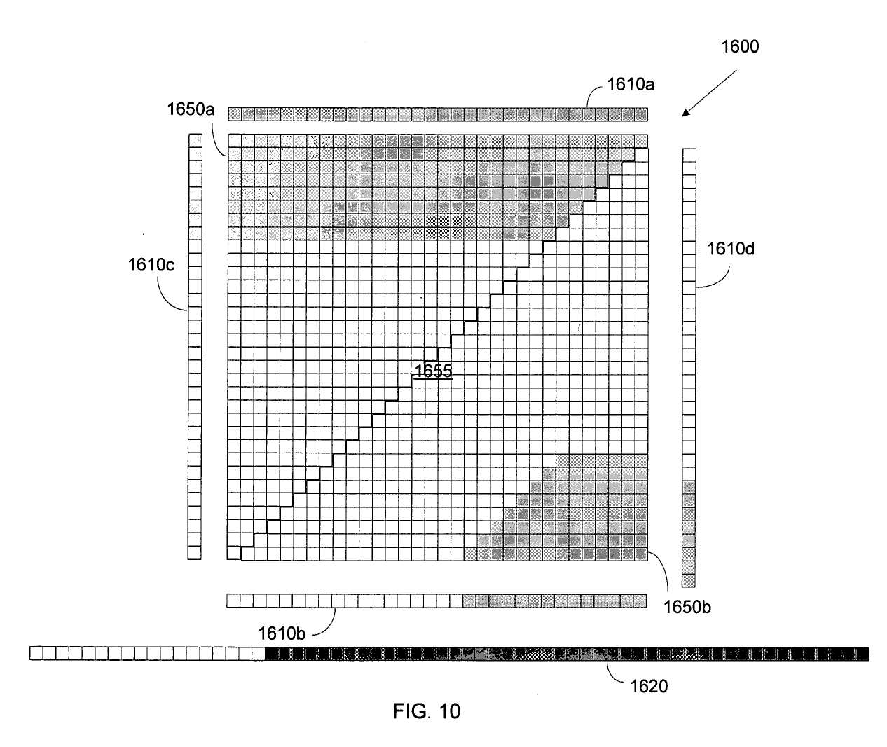

The physical layout of the matrix may be configured in any number of different ways. For example, the physical space saved by incorporating various aspects of the present invention (e.g., regions 660a and 660b in FIG. 6) need not be separated as shown in the embodiments of FIGS. 6-9. In particular, regions 660a and 660b may be made contiguous by arranging the matrix in a generally square configuration. FIG. 10 illustrates a multiplier circuit 1600 having a matrix portion 1650a and a matrix portion 1650b arranged such that, together, matrix 1650 is arranged essentially as a square. As a result, the space savings may be consolidated into a single contiguous area. Numerous other arrangements may be suitable, and the invention is not limited in this respect.

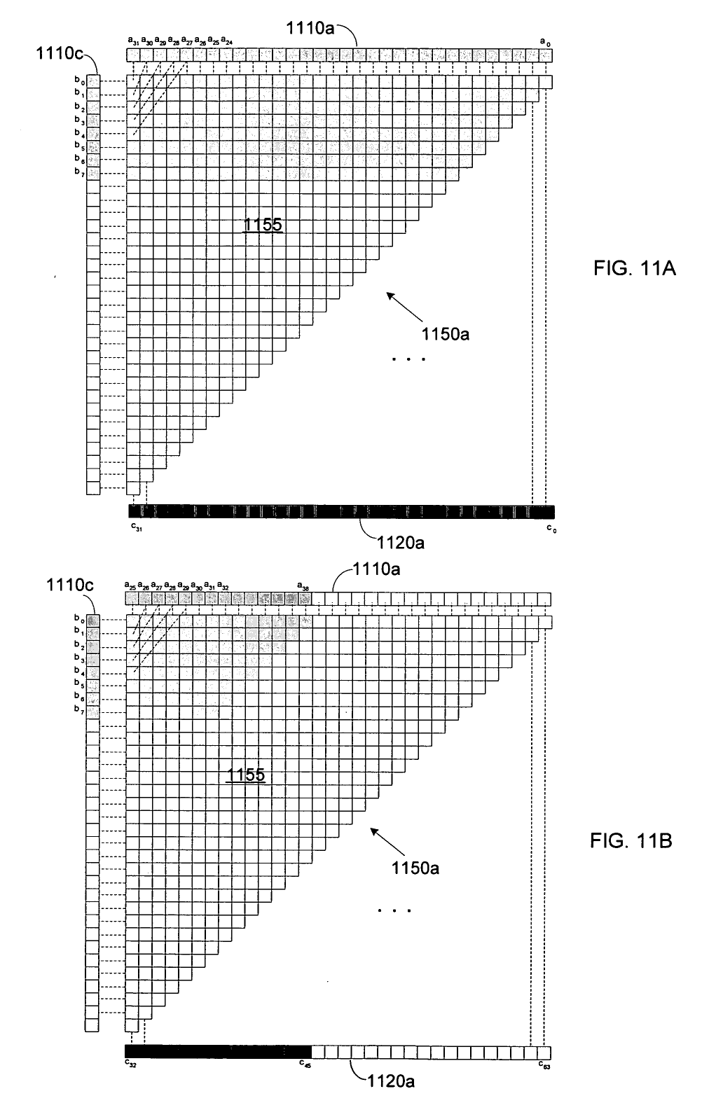

Applicant has appreciated that hardware may be further reduced by performing, in series, two initializations and two partial multiplications. FIG. 11 illustrates one embodiment of a multiplier 1100 according to the present invention. Matrix 1150 may be substantially the same as matrix 650a along with the associated registers of multiplier 600 illustrated in FIGS. 6-10. In particular, multiplier 1100 includes input registers 110a and 1110c to store portions of the operands of a multiplication and output register 1120a to store a partial product. The various registers are connected to matrix 1150 as described in connection with multiplier 600.

It should be appreciated that matrices 650a and 650b in multiplier 600 operate independently of one another, i.e., neither matrix requires or is dependent on the other nor on the data stored in the registers connected to the other. Accordingly, to perform any of the exemplary multiplications described above, matrix 1150 may be initialized in the same manner as matrix 650a is initialized. Once initialized, matrix 1150 computes the partial product and stores the result in output register 1120a. This value may then be loaded and stored in another temporary register, i.e., another register or memory location of a DSP. Matrix 1150 may then be re-initialized, this time in the same manner as matrix 650b to provide another partial product to output register 1120. The two partial products together form the full product of the two operands. As a result, the hardware may be substantially halved again at the expense of some computation time.

The flexibility that may be achieved with essentially full variable length multiplication (within a prescribed output bandwidth) may be less important to some applications as time and/or space constraints. Accordingly, by placing some constraints on operand lengths, further hardware reductions may be achieved. For example, consider an instruction of the form,
Rsq=PMUL Rmq (2)

Where PMUL is the opcode, Rmq is a register for storing the operands for the multiplication and Rsq is a register to store the product of the operands in Rmq. For example, Rsq may be a 128-bit register (e.g., a quad-register of 32 bits each), defining the output bandwidth of a DSP.

In one embodiment Rmq may be a 128 bit register where the first 96 bits (e.g., Rm2:0) stores a first operand and the last 32 bits (e.g., Rm3) stores a second operand. Accordingly, the maximum length of the first operand is fixed at 96 bits and the maximum length of the second operand is fixed at 32 bits to produce a maximum length product of 127 bits. When the first operand is less than 96 bits, the second operand may not be permitted to exceed 32 bits (and vice versa) as in the variable length multiplication described above. The fixed lengths may be of any size, but respective operands may not exceed the length once fixed.

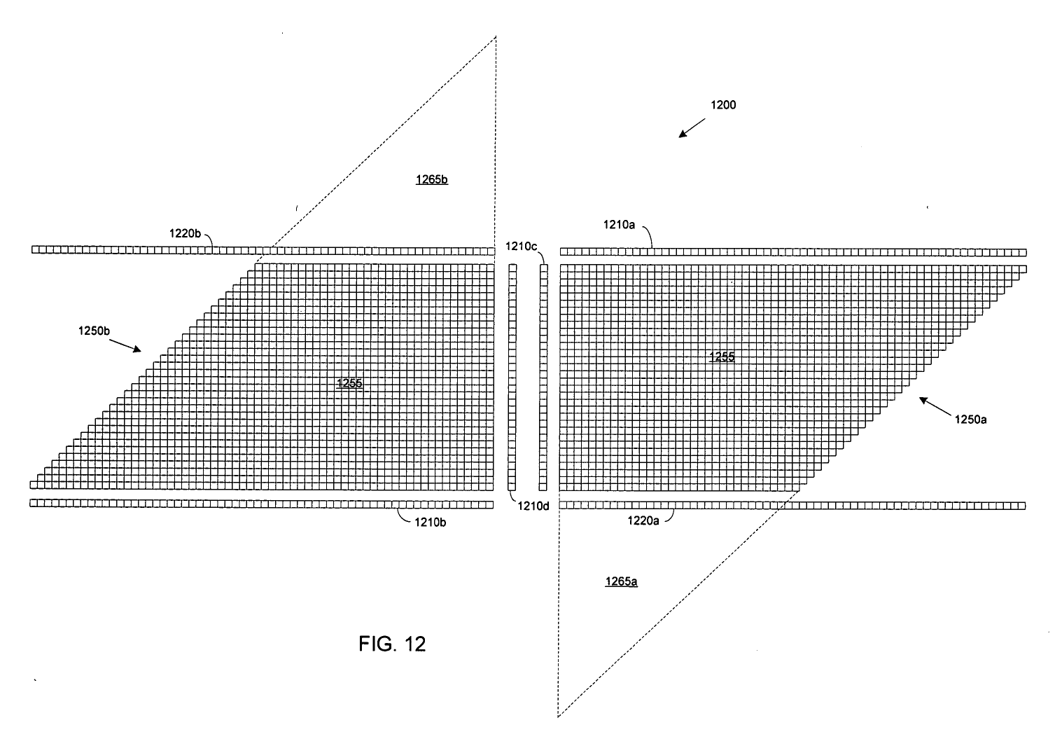

FIG. 12 illustrates one embodiment of a fixed maximum length multiplier 1200 having first matrix portions 1250a and 1250b. Matrix portion 1250a and matrix portion 1250b form polygons rather than triangles. In multiplier 1200, input registers are comprised of a pair of 32-bit registers for the second operand and a pair of 64-bit registers for the first operand. The reduction in hardware from a variable length implementation of the same output bandwidth is shown by regions 1260a and 1260b, i.e., the space necessary to make the characteristic triangular shape of matrices 650a and 650b from matrices 1250a and 1250b, respectively.

Initialization of multiplier 1200 may also be less complicated than variable length counterparts. In particular, since the maximum length of each operand is independent of the other operand, appropriate initialization can proceed without first determining a length of the shorter operands. Accordingly, the second operand may be loaded into input registers 1210c and 1210d. Since the maximum length of the second operand is known, the initialization of registers 1210a and 121b will be the fixed. For example, bits of a₀-a₆₃ of the first operand may be loaded into register 1210a and bits a₃₃-a₉₅ may be loaded into register 1210b. Once initialized, matrix 1200 performs the full multiplication of the operands stored in input registers 1210 and stores the product in output registers 1220 (i.e., registers 1220a and 1220b).

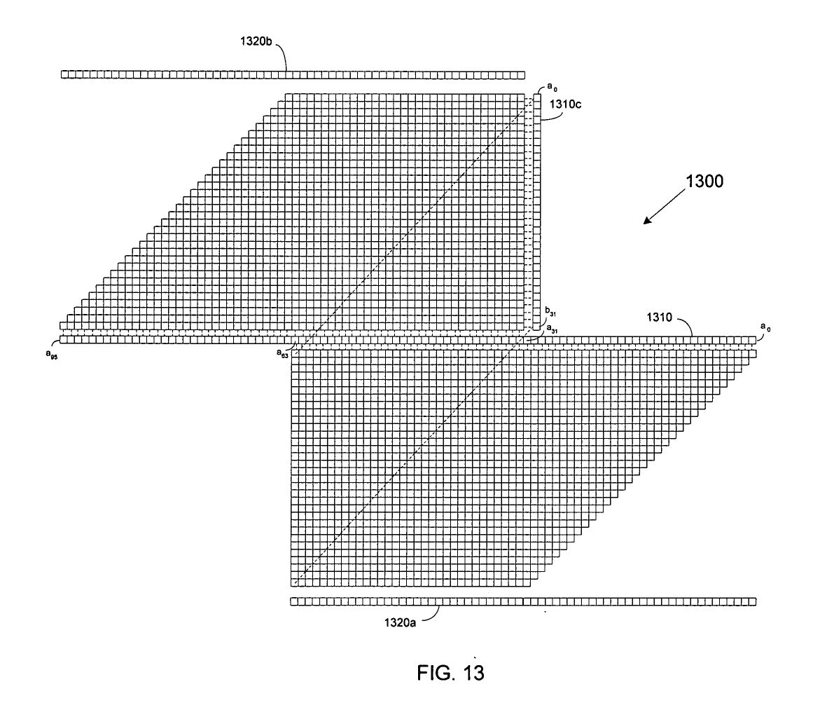

FIG. 13 illustrates another embodiment of a fixed length multiplier 1300. Applicant has appreciated that, rather than providing a pair of input registers for each operand, matrix portions 1350a and 1350b may be appropriately connected to a single input register for each operand to compute the corresponding product. For example, input register 1310c may be a 32 bit register and input register 1310a may be a 96 bit register. Initialization of multiplier 1300 may include simply loading the corresponding operands into the appropriate registers. For example, a first operand may be loaded into register 1310c from the LSB at b₀ to the MSB and b₃₁ and a second operand may be loaded into register 1310a from the LSB at a₀ to the MSB at a₉₅. It should be appreciated that the repeat bits associated with the length of the first operand are accommodated by connecting bits a₃₂-a₆₃ to both arrays.

Once the input registers have been appropriately initialized, multiplication circuit 1300 can compute the product of the first and second operands stored, for example, in register Rmq.

The various embodiments of multiplication circuits described in the foregoing may be employed in any type of multiplication operation. For example, the multipliers may be incorporated into a DSP to facilitate long code generation in a communications environment. Multiplication operations may be performed in modulator/demodulators (modems) of various wireless devices. In particular, a multiplier may provide important functionality in sequence generators that compute PN codes in a CDMA communications environment, such as various sequence generators described in U.S. application Ser. No. 10/643,777 by Wei An, which is incorporated by reference herein in its entirety.

For example, CDMA communications systems often employ PN codes to enable transmission of multiple signals using a common channel (e.g., over the same frequency band). A transmitter may transmit a data communications signal modulated by a unique PN code over a frequency band shared by the one or more other transmitters. The data communications signal may be demodulated by one or more receivers by demodulating the data communications signal with a local replica of the same PN code.

PN codes have the generally desirable characteristic that signals modulated and demodulated with the same PN code appear strongly correlated while all other signals modulated and demodulated with different PN codes appear as background noise. Accordingly, multiple signals transmitted over the same channel may be distinguished from one another by demodulating appropriately with the respective PN code employed during transmission of the signal.

PN codes are often generated using a linear feedback shift register (LFSR) implemented either in hardware, software or a combination of both. When an appropriately connected linear feedback register (e.g., an LFSR connected according to a maximal length sequence or M-sequence) is operated, the LFSR produces a periodic pseudo-random sequence, wherein the period depends in part on the length of the LFSR (e.g., the number of stages or storage elements in the LFSR).

In a wireless communications system, this pseudo-random sequence provides a reference sequence from which various devices communicating within the system generate their own unique PN code. Each PN code may be an offset of the reference sequence. By modulating a communication transmitted by a device in the system with its respective PN code, the various communications can be transmitted over the same channel and sorted out at the receiving end by demodulating the signals in the channel with the same PN codes by which they were modulated. Accordingly, if a receiver, such as a base station, is aware of the PN code with which a communication was modulated, it can separate the communication from the channel.

An offset of a reference sequence may be generated by masking an LFSR arranged to generate the reference sequence. Masking may involve taking an inner product between the stage of an LFSR and a desired mask. Each mask produces a different offset sequence. Accordingly, for a transmitter/receiver pair operating on a particular reference sequence, the receiver can generate the transmitter's unique PN code from the reference sequence if the receiver is aware of the specific mask that will generate the sequence at the offset of the PN code.

For LFSR implementations in software, masking is a relatively expensive computation. However, as discussed in detail in the '777 application, various techniques may be performed that may obviate the need to perform masking operations. Such techniques as well as other operations that facilitate implementing LFSR code generation in software may rely on fast computation of polynomial multiplication.

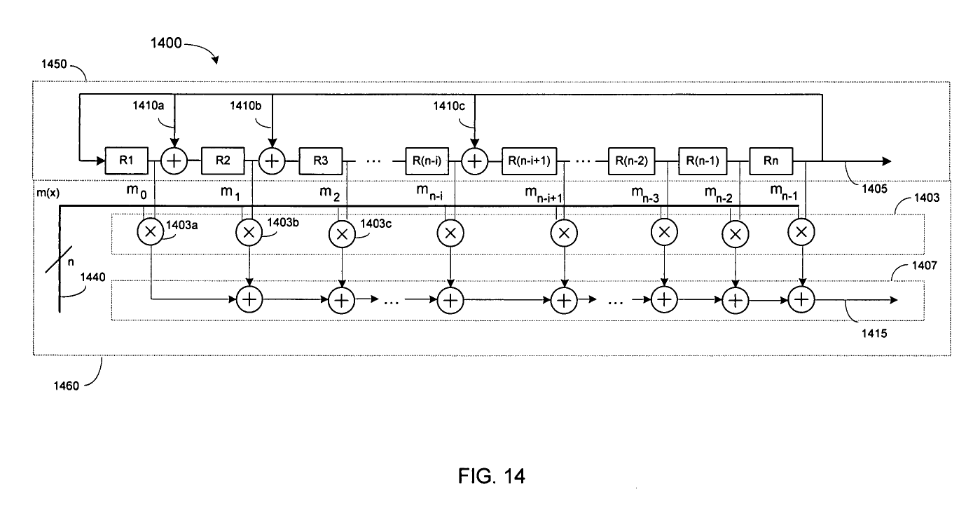

For example, FIG. 14 illustrates a conventional method of generating offset PN codes by masking an LFSR. LFSR 1450 is an n-stage (i.e., stages R1-Rn) sequence generator having feedback connections 1410 that produce an M-sequence. Accordingly, LFSR may continually produce a binary sequence at output 1405 having a period of 2ⁿ−1. In the wireless communications environment, for example, each transceiver/receiver may include a sequence generator similar to generator 1400 that is in phase or is capable of being placed in phase with one another such that they can produce the same sequence. This sequence may be used by the communications system as a reference sequence from which various offset sequences may be produced.

Conventional LFSR generators often produce offsets from a reference sequence by providing a mask to the state vector of the LFSR. The term “state” or “state vector” refers generally to a unique configuration of a sequence generator from which a chip (e.g., a bit) of a base sequence at a particular phase is generated. For example, the state vector of an LFSR refers to the n-bit binary number stored in register R, i.e., the binary number stored in storage elements R1-Rn. The state vector of an LFSR may be masked to provide an offset sequence at output 1415 such that output 1415 is shifted from the reference sequence provided at output 1405.

For example, LSFR 1400 includes an offset generator 1460 coupled to LFSR 1450. Offset generator 1460 includes a plurality of multiplication elements 1403 having first input connected to respective outputs of the registers R1-Rn and a second input connected to respective bits of a mask 1440 represented as a plurality of bits m₀−mₙ₋₁. The output of multiplication elements 1403 may be provided to a plurality of summing elements 1407. The summing elements 1407 may be connected such that the output of multiplication element 1403a is first summed with the output of multiplication element 1403b. This sum may then be summed with the output of 1403c and so on such that the final sum provides binary sequence 1415.

Masking exploits the so-called “shift-and-add” property of M-sequences. This property is known to those skilled in the art and will not be discussed in detail herein except to say that the property derives from the appreciation that when a portion of an M-sequence is summed with an offset of itself, it produces a portion of the same M-sequence at another offset. Multiplication elements 1403 and summing elements 1407 form an inner product of the state vector of the LFSR and the mask. This inner product invokes the shift-and-add property such that a binary sequence 1415 may be produced at an offset from the reference sequence 1405 by an amount depending on the mask 1440. Accordingly, multiple offset sequences may be produced from a single reference sequence by applying different masks.

In the communications system discussed above, each transmitter may have a unique mask assigned to it. The mask may be known by the various other transmitters, receivers or other components adapted to communicate with the transceivers. Accordingly, a transmitter/receiver pair both may be capable of generating an offset sequence corresponding to the mask assigned to the transmitter (i.e., both may be capable of generating the same unique PN code).

However, while the LFSR designs of FIG. 14 may be well suited for hardware implementations, software implementations may suffer from the relatively expensive computations required to generate both the reference sequence and the offset sequence. For example, in hardware, the n stages may be implemented by individual clocked flip-flops or similar storage elements. Multiplication elements 1403 may be implemented as logic AND gates and summing elements 1407 may be implemented as exclusive-or (XOR) gates. Each successive clock pulse may produce a subsequent bit of the reference sequence at output 1405 and a subsequent bit of the offset sequence at output 1415. Accordingly, the speed of generating an offset sequence in hardware may be linearly related to clock speed.

It should be appreciated that the sequence generators, e.g., LFSRs and offset generators may be implemented in software. In particular, the various computations (e.g., summing and multiplying various binary values according to a characteristic polynomial, masking computations, etc.) may be implemented as instructions, for example, of a program encoded in memory and capable of being executed on one or more processors such as a DSP.

However, providing a reference sequence in software may require a relatively large numbers of clock cycles. For example, the contribution of each feedback connection may need to be computed and the state of the LFSR updated. In addition, generating a single bit of an offset sequence requires computing the inner product of two n-bit sequences. When n is large (e.g., 42 bits in CDMA2000), mask computations may prohibit offset sequences from being generated at speeds sufficient to satisfy the relatively stringent requirements of many applications such as cellular communications, etc.

A non-masked LFSR may produce the same offset sequence as a masked LFSR when placed in an appropriate initial state by determining an initial state vector from a given mask that, when applied to a non-masked LFSR, generates an offset sequence associated with the given mask. The term “initial state vector” refers to a state vector from which a sequence generator initiates a sequence at some desired phase of a base or reference sequence. That is, the initial state vector provides a first bit of a sequence at some desired phase of a base sequence. As such, operating a sequence generator (e.g., an LFSR) from an initial state vector or from an initial state refers to placing a sequence generator in the initial state to initiate generating a sequence at a corresponding phase of a reference sequence. This act may also be referred to as applying an initial state vector or initial state to a sequence generator.

It is known that an LFSR that generates an M-sequence passes uniquely through every 2ⁿ−1 state vectors associated with the n stages of the LFSR. Accordingly, each state vector produces a bit of the M-sequence at a unique phase. At some time t₀, for example, when a mask is applied to an LFSR, the LFSR is in a particular state that generates a first bit of a reference sequence at some phase of a base sequence. At the same time t₀, the inner product of the mask and the state vector of the LFSR produce a first bit of an offset sequence. Since the offset sequence and the reference sequence are offset versions of the same base sequence, at some time tᵢ the reference sequence will achieve the same phase as the offset sequence at time t₀. Also at time tᵢ, the LFSR will be in some unique state. That is, a unique state vector of the LSFR corresponds to the first bit of the offset sequence generated by the mask at time t₀.

Accordingly, an offset sequence generated by masking an LFSR may be alternatively generated by a non-masked LFSR by applying the appropriate state vector to the LFSR. As discussed in detail in the '777 application, the state vector corresponding to a desired offset sequence may be determined by performing various operations on the mask, including multiplication. For example, any state g′ₖ(x) of a non-masked LFSR corresponding to the masked LFSR at an arbitrary state gₖ(x) (e.g., the current state of the LFSR) may be determined according to the relationship,
g′ₖ(x)=mod{g′₀(x)·gₖ(x), p(x)} Equation 1

where g′₀(x) is a special state (the derivation of which is described in detail in the '777 application), gₖ(x) is a current state of the LFSR, g′ₖ(x) is the desired initial state vector, p(x) is the characteristic or generator polynomial, and the mod{x, y} operation performs the modulus or remainder of x divided by y, where division is a Galois field operation. The proof of the expression in equation 1 is provided in the application '777, and shown herein to illustrate that computation of an initial state vector may include at least one multiplication operation.

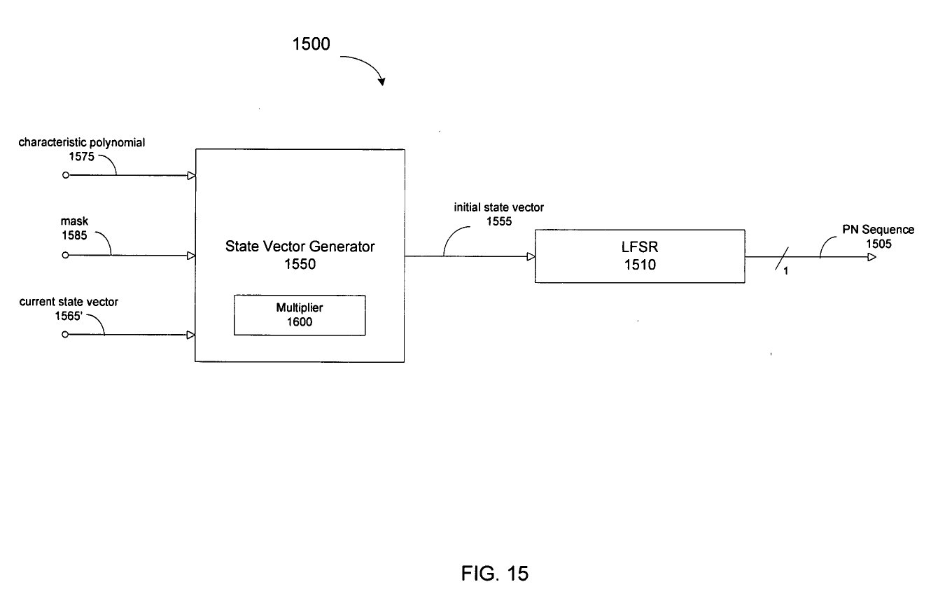

FIG. 15 illustrates a functional diagram of a sequence generator having a non-masked LFSR. For example, sequence generator 1500 may include a non-masked LFSR 1510. Non-masked LFSR 1510 may be implemented in software or hardware. Sequence generator 1500 may further include a state vector generator 1550. State vector generator 1550 may be configured to compute an initial state vector 1555 associated with a mask 1585. State vector generator 1550 may be, for example, a program or set of instructions configured to compute an initial state vector based on a given mask 1585, a characteristic polynomial 1575 implemented by LFSR 1510, and a current state vector 1565′ of the LSFR. State vector generator 1550 may provide the generated initial state vector 1555 to LFSR 1510 such that a desired offset PN sequence 1505 is produced. State vector generator 1550 may include a multiplier 1600 to handle multiplication operations involved in computing an initial state vector (e.g., the multiplication operation expressed in equation 1).

The current state vector 1565′ may be associated with a reference sequence. For example, the reference sequence may be simultaneously generated by each of various transceivers in a communication system. It should be appreciated that current state vector 1565′ may be obtained either from non-masked LFSR 1510 at a time when it is generating the reference sequence or may be obtained from a separate LFSR (not shown). In particular, a sequence generator may have a first LFSR to generate the reference sequence and a second LFSR to generate an offset sequence of the reference sequence, or both sequences may be generated by the same LFSR.

Once the initial state vector has been applied to the LFSR, each bit requires computing the various feedback connections of the LFSR. For example, each time the feedback connections are computed (i.e., each time LFSR 1510 is effectively shifted) a single bit is produced at output 1505. For LFSR implementations in software, these computations may be relatively expensive. For example, computations include an XOR operation for each feedback connection required by the characteristic polynomial. In addition, the state of the LFSR must be updated for the next iteration, and other computations may need to be performed for each bit generated on each iteration.

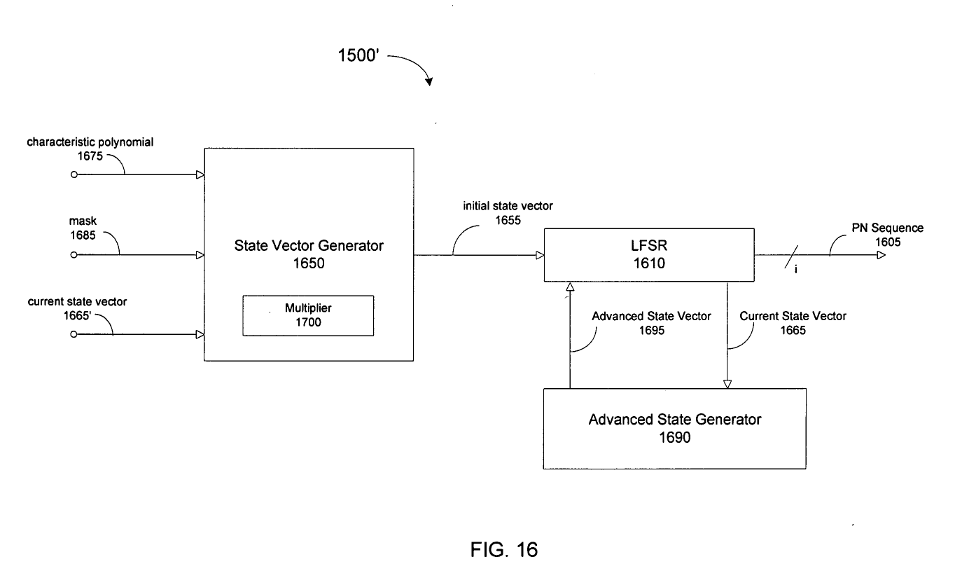

As further described in the '777 application, properties of a characteristic polynomial of an LFSR may be exploited to simultaneously generate multiple bits of a binary sequence. That is, the arrangement of feedback connections may yield multiple bits of a binary sequence simultaneously. In particular, multiple bits may be output simultaneously where the number of simultaneous bits is related to a difference in order between the highest order non-zero term and the second highest order non-zero term. This order difference yields a series of stages of the LFSR having no feedback connections. The absence of feedback connections allows corresponding bits of the LFSR to be output simultaneously. FIGS. 16A and 16B illustrate this concept.

FIG. 16A illustrates an n-bit LFSR having feedback connections as required by a characteristic polynomial (not shown). The i highest order stages of the LFSR have no feedback connections between them. That is, the characteristic polynomial has zero coefficients for the xⁿ⁻¹-x⁽ⁿ⁻ⁱ⁺¹⁾ terms. As a result, the i values stored in the corresponding stages do not change as they shift toward the output 1605 and may be available simultaneously and considered as an i-bit sequence. For example, FIG. 16B illustrates a LFSR implementing the characteristic polynomial established by CDMA2000. In this arrangement, seven bits may be made available simultaneously.

The availability of multiple bits may not be useful if only a single new bit is generated for each iteration that is, if the LFSR is shifted by a single bit on each iteration. However, the LFSR may be effectively shifted i times by computing a state of the LFSR advanced from a current state by i states. Provided that the i^{th} next state can be computed, i bits may be available on each iteration without having to shift (and compute feedback connections) i separate times. Instead, an LFSR may be advanced to the computed state and another i bits may be provided. As described in the '777 application, one method of determining an advanced state vector may be performed according to the expression,
gₖ₊ᵢ(x)=vₖ(x)+uₖ(x)·q(x) Equation 2,

where gₖ₊ᵢ(x) is the current state vector advanced by i states, vₖ(x) and uₖ(x) are partial state vectors of the LFSR and q(x) is a portion of the generator polynomial p(x) as described in detail in the '777 application. The operation includes a multiplication operation that may be performed by any of the various multipliers described herein.

FIG. 17 illustrates one embodiment of a sequence generator that computes advanced state vectors in order to advance the sequence generator a desired number of states without incrementing through intervening states. Sequence generator 1700 may be similar to the sequence generator described in connection with FIG. 15. However, sequence generator 1700 may include an advanced state generator 1790. As described in connection with FIGS. 16A and 16B, a number of bits i may be simultaneously output from an LFSR where i may be equal to the difference between the order of an associated characteristic polynomial and the order of the next highest order non-zero term.

However, in order to take advantage of this property, an LFSR must be advanced i states without having to iterate i times. The term “advance” refers generally to moving a state of a sequence generator from a first state to a subsequent state without transitioning through intervening states.

Advanced state generator 1790 may be coupled to LFSR 1710 to provide LFSR 1710 with a desired state and such that it can obtain a current state of LFSR 1710. At some point in time, the most significant i bits of a current state vector may be simultaneously provided as PN sequence 1705. It should be appreciated that current state vector 1765 is associated with an offset sequence and current state vector 1765′ is associated with a reference sequence.

Advanced state generator 1790 may then compute a subsequent or next state vector offset from the current state vector by i iterations. Advanced state generator 1790 may then apply the computed subsequent state vector to LFSR 1710. As a result, i bits may be computed for each iteration of sequence generator 1700. Advanced state generator 1790 may include a multiplier 1700 to handle the polynomial multiplication operations performed in computing the advanced state vector. Multiplier 1700 may be any of the various embodiments of multipliers described in the foregoing. Multiplier 1700 may be the same multiplier used to compute initial state vector 1755 or may be a separate multiplier.

It should be appreciated that during operation of sequence generator 1700 one more polynomial multiplications may be performed to generate the initial state vector and one or more multiplication operations may be performed to generate each advanced state vector. Accordingly, fast polynomial multiplication may be needed in order to meet time constraints imposed by, for example, communications between cellular devices, while not demanding large areas of DSP chip area. In addition, power consumption may be an important in communications systems using battery powered devices. Accordingly, conventional hardware multipliers are furthered disadvantaged due to the relatively large amount of power consumed, for example, due to excess circuitry that needs to be maintained and initialized to zero as discussed in the foregoing. Accordingly, various aspects of the present invention may be employed to provide multipliers for communications devices that perform fast and relatively efficient polynomial multiplication.

Various aspects of the present invention may be may be used alone, in combination, or in a variety of arrangements not specifically discussed in the embodiments described in the foregoing and is therefore not limited in its application to the details and arrangement of components set forth in the foregoing description or illustrated in the drawings. The invention is capable of other embodiments and of being practiced or of being carried out in various ways. In particular, various aspects of the present invention may be practiced with processing devices of a number of types, arrangements, architectures and capabilities. No limitations are placed on the device implementation.

In addition, various aspects of the invention described in one embodiment may be used in combination with other embodiments and is not limited by the arrangements and combinations of features specifically described herein. Various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A multiplier for performing multiplication of a first operand and a second operand, the multiplier comprising:
a matrix having a plurality of matrix elements arranged in a plurality of columns;
a first plurality of storage elements to store at least a portion of the first operand, the first plurality of storage elements connected diagonally to the matrix; and
a second plurality of storage elements to store at least a portion of the second operand, the second plurality of storage elements connected vertically to the matrix.

2. The multiplier of claim 1, further comprising a third plurality of storage elements to store a product of the first operand and the second operand, the third plurality of storage elements forming a number of storage elements defining an output bandwidth of the multiplier.

3. The multiplier of claim 2, wherein the first plurality of storage elements forms a first input register and a second input register capable of storing the first operand.

4. The multiplier of claim 3, wherein the matrix includes a first matrix portion and a second matrix portion and wherein the first input register is connected diagonally to the first matrix portion and the second input register is connected diagonally to the second matrix portion.

5. The multiplier of claim 4, wherein a least significant bit position of the first input register provides an initial bit to a first column of the plurality of columns having only a single matrix element of the first matrix portion and a most significant bit position of the first input register provides an initial bit to a second column of the plurality of columns having N matrix elements of the first matrix portion.

6. The multiplier of claim 5, wherein a least significant bit position of the second input register provides an initial bit to a third column of the plurality of columns having N−1 matrix elements of the second matrix portion and a most significant bit position of the second register provides an initial bit to a fourth column of the plurality of columns having only a single matrix element of the second matrix portion.

7. The multiplier of claim 6, wherein each bit position from the least significant bit position to the most significant bit position of the first input register provides an initial bit to a respective column of the plurality of columns having a successively greater number of matrix elements of the first matrix portion.

8. The multiplier of claim 7, wherein each bit position from the least significant bit position to the most significant bit position provides an initial bit to a respective column having a successively fewer number of matrix elements of the second matrix portion.

9. The multiplier of claim 8, wherein each column of matrix elements included in the first matrix portion and each column of matrix elements included in the second matrix portion compute a respective output bit of the product of the first operand and the second operand, wherein each output bit is provided to a respective one of the third plurality of storage elements.

10. The multiplier of claim 9, wherein the second plurality of storage elements forms at least a third input register and wherein each matrix element receiving an initial bit includes an AND gate having the respective initial bit as a first input and a least significant bit of the third input register.

11. The multiplier of claim 10, wherein each matrix element not receiving an initial bit includes an AND gate and an XOR gate.

12. The multiplier of claim 1, in combination with at least one sequence generator, the at least one sequence generator comprising a register for storing a current state vector defining one of a plurality of states from which an output sequence is generated, wherein the current state vector is computed from a product computed by the multiplier.

13. The combination of claim 12, wherein the sequence generator further comprises a state generator coupled to the register, the state generator adapted to determine a next state vector advanced from the current state vector, and wherein the next state vector is determined based at least on a product computed by the multiplier.

14. The combination of claim 13, further in combination with at least one wireless device comprising at least one sequence generator, wherein the at least one wireless device is adapted to generate a PN code for modulating communications of the wireless device via the at least one sequence generator.

15. The combination of claim 14, further in combination with at least one base station comprising at least one sequence generator, wherein the at least one base station is adapted to demodulate communications via the at least one sequence generator.

16. A multiplier for performing multiplication of a first operand and a second operand, the multiplier comprising:
a plurality of matrix elements logically arranged in a plurality of computation elements, each computation element connected serially to compute an output bit of a product of the first operand and the second operand;
a first plurality of storage elements to store at least a portion of the first operand, the first plurality of storage elements connected to the plurality of matrix elements such that each of the plurality of first storage elements provides a value stored therein to no more than one matrix element at any rank in any one of the plurality of computation elements except within the computation element to which the storage element provides an initial bit; and
a second plurality of storage elements to store the second operand, the second plurality of storage elements connected to the plurality of matrix elements such that each of the plurality of second storage elements provides a value stored therein only to matrix elements of a same rank.

17. The multiplier of claim 16, further comprising a third plurality of storage elements to store a product of the first operand and the second operand, the third plurality of storage elements forming a number of storage elements defining an output bandwidth of the multiplier.

18. The multiplier of claim 17, wherein the first plurality of storage elements forms a first input register and a second input register capable of storing the first operand.

19. The multiplier of claim 18, wherein the matrix includes a first matrix portion and a second matrix portion and wherein the first input register is connected diagonally to the first matrix portion and the second input register is connected diagonally to the second matrix portion.

20. The multiplier of claim 19, wherein a least significant bit position of the first input register provides an initial bit to a first column of the plurality of columns having only a single matrix element of the first matrix portion and a most significant bit position of the first input register provides an initial bit to a second column of the plurality of columns having N matrix elements of the first matrix portion.

21. The multiplier of claim 20, wherein a least significant bit position of the second input register provides an initial bit to a third column of the plurality of columns having N−1 matrix elements of the second matrix portion and a most significant bit position of the second register provides an initial bit to a fourth column of the plurality of columns having only a single matrix element of the second matrix portion.

22. The multiplier of claim 21, wherein each bit position from the least significant bit position to the most significant bit position of the first input register provides an initial bit to a respective column of the plurality of columns having a successively greater number of matrix elements of the first matrix portion.

23. The multiplier of claim 22, wherein each bit position from the least significant bit position to the most significant bit position provides an initial bit to a respective column having a successively fewer number of matrix elements of the second matrix portion.

24. The multiplier of claim 23, wherein each column of matrix elements included in the first matrix portion and each column of matrix elements included in the second matrix portion compute a respective output bit of the product of the first operand and the second operand, wherein each output bit is provided to a respective one of the third plurality of storage elements.

25. The multiplier of claim 24, wherein the second plurality of storage elements forms at least a third input register and wherein each matrix element receiving an initial bit includes an AND gate having the respective initial bit as a first input and a least significant bit of the third input register.

26. The multiplier of claim 25, wherein each matrix element not receiving an initial bit includes an AND gate and an XOR gate.

27. The multiplier of claim 16, in combination with at least one sequence generator, the at least one sequence generator comprising a register for storing a current state vector defining one of a plurality of states from which an output sequence is generated, wherein the current state vector is computed from a product computed by the multiplier.

28. The combination of claim 27, wherein the sequence generator further comprises a state generator coupled to the register, the state generator adapted to determine a next state vector advanced from the current state vector, and wherein the next state vector is determined based at least on a product computed by the multiplier.

29. The combination of claim 28, further in combination with at least one wireless device comprising at least one sequence generator, wherein the at least one wireless device is adapted to generate a PN code for modulating communications of the wireless device via the at least one sequence generator.

30. The combination of claim 29, further in combination with at least one base station comprising at least one sequence generator, wherein the at least one base station is adapted to demodulate communications via the at least one sequence generator.

31. A multiplier for computing at least a partial product of a first operand having a first length and a second operand having a second length, the multiplier comprising:
a first register to store at least a portion of the first operand;
a second register to store at least a portion of the second operand; and
a logic matrix formed from a plurality of matrix elements that together perform a multiplication operation, the logic matrix connected to the first register and the second register such that each matrix element receives at least one bit from the first register and at least one bit from the second register,
wherein a number of the plurality of matrix elements does not exceed a product of the first length and the second length.

32. The multiplier of claim 31, wherein the number of the plurality of matrix elements does not exceed ¾ the product of the first length and the second length.

33. A multiplier for performing multiplication of a first operand and a second operand, the multiplier comprising:
a first register to store at least a portion of the first operand; and
a plurality of matrix elements arranged in groups, each group connected to compute a respective output bit of a product between the first and second operand,
wherein a first matrix element in each group is connected to receive a respective initial bit of the first register, each group having a number of matrix elements less than or equal to a bit position of the first register storing the respective initial bit.

34. The multiplier of claim 33, wherein the first register is connected diagonally to the plurality of matrix elements.

35. The multiplier of claim 34, further comprising a second register to store at least a portion of the second operand, the second register connected vertically to the plurality of matrix elements.
